(19) United States
(12) Patent Application Publication
(10) Pub. No.: US 2007/0164845 A1
(43) Pub. Date: Jul. 19, 2007

(54) System and method for monitoring security systems

(75) Inventors: David Ivins, Bracknell (GB); Nathaniel Lacsamana, Bridgewater, NJ (US); Michael Rapp, Modautal (DE); James Macchia, Washington Township, NJ (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Checkpoint Systems, Inc., Thorofare, NJ (US)

(21) Appl. No.: 11/311,556

(22) Filed: Dec. 19, 2005

Related U.S. Application Data
(60) Provisional application No. 60/637,973, filed on Dec. 21, 2004.

(51) Int. Cl. G05B 23/02

(52) U.S. Cl. 340/3.9; 340/572.1

(57) ABSTRACT

A system for monitoring security systems including at least one pedestal set; a reason code generator; a computer to compile data received from the at least one pedestal set, and a graphical display to display the compiled data received from the pedestal set in the form of a maps of locations. An IP camera configured to operate for a period of time during the alarm event may be included. A method for monitoring security systems is also provided which includes providing at least one pedestal set, passing a tag through the pedestal set to create an event, generating a reason for the event observed by the pedestal set, compiling batches of data received from the at least one pedestal set; and graphically displaying the compiled data received from the pedestal set in the form of a maps of locations.

### CROSS-REFERENCE TO RELATED APPLICATION

This application claims priority to U.S. Provisional Patent Application Ser. No. 60/637,973, filed Dec. 21, 2004, entitled System and Method for Monitoring Security Systems.

### SPECIFICATION

### BACKGROUND OF THE INVENTION

This invention relates intelligent security systems. More particularly, the present invention is directed to an intelligent system and method for monitoring security systems.

The present invention is directed to an intelligent system and method for monitoring security systems that automates many functions that previously required manual input by an operator. The security system is designed to operate with radio frequency (RF) security apparatus such as electronic article security (EAS), AM and radio frequency identification (RFID) systems and tags. The present system may be used in any location for which there is a need for tracking items or protecting items from theft. The present system could be deployed, for example, in a retail store, shipping facility, warehouse, airport, library, and the like.

Several companies manufacture and sell intelligent RF security systems. For example, Sensormatic Electronics Corporation, a subsidiary of Tyco International, Ltd., markets a system that performs real-time monitoring of stores that has the ability to interface with store alarms, has remote diagnostic hardware, performs data mining, and counting of people passing through a detection area. This system also performs electronic entry of alarm logs and has the ability to link video surveillance cameras. Sensormatic also has a system that enables store employees to track alarms, based on information input into a panel. This system automatically records elapsed response time, reason, location, and system status. Using a keypad or scanner, point of sale information such as the specific aisle or cashier used and quantity and identification of items recovered can be logged. An alarm incident report becomes part of a centralized database that is accessible, for example, via the internet or by e-mail. The Sensormatic system also can link EAS deactivation with a point of sale transaction. The system provides a record of all deactivations. A Sensormatic system also records information on the number of people entering and exiting stores which may be automatically transmitted to corporate headquarters. Finally, a Sensormatic system manages RFID readers remotely.

U.S. Patent Application Publication No. 2004/0164863, by Sensormatic (Tyco Fire & Security Services, as noted on the publication) is directed to an integrated EAS and point of sale system and method where a computer receives and processes EAS data together with point of sale data for use by a user. This patent also includes several other features including a timer that is initiated upon receiving an alarm. The timer is stopped in response to input by a user. In operation, the system receives an alarm event corresponding to an activated EAS tag. Information related to the alarm event is made available, including a reason code (such as failure to deactivate, failure to remove, stock movement, system test, unexplained, unattended, etc.). A keypad or scanner may be used to input the alarm event information. See also International Published Application No. WO 2004/077362, by Sensormatic.

N.V. Nederlandsche Apparatenfabriek (NEDAP) of the Netherlands also markets a system that counts people, such as customers entering and leaving an area. This information is used to determine the effectiveness of marketing campaigns or can be compared with point-of-sale alarm data to determine how best to deploy sales and security staff. This system shows incoming and outgoing customers passing through an area in a designated time period, allows an operator to survey relevant data, compares current data to data received during previous time periods, shows a correspondence between the number of alarms and number of visitors, etc. NEDAP also makes a security system monitor that provides an operator with EAS system status (e.g. fully operational, possible fault causes and solutions, etc.). NEDAP also markets software that monitors tag and tagging performance, including quantity and quantity of deactivated tags. The system provides remote service and on-line maintenance options.

European Patent No. EP 1 226 565, by NEDAP, is directed to a system for monitoring theft protection. Here, the system includes a transceiver disposed adjacent to a passage that detects antitheft labels passing through the passage. The system includes a communications device that transmits, in real time, information about the detected labels. The system is arranged for manual input and real-time transmission of information regarding antitheft labels attached to paid-for goods. When a security officer has established that a detection originates from an antitheft label attached to a paid-for article, at lease one local control system and/or the central control system is provide with this information. Real time information may be processed remotely. The central control device may statistically process the information received. A display may be used where a city may be selected and information related to that city is displayed.

European Patent Application No. EP 1 411 484, owned by NEDAP, is directed to a real time system for monitoring theft protection. Similar to EP 1 226 565, this system is directed to a theft security device having a transceiver that is set up in a passageway and detects antitheft labels that pass through the passageway. The system may include provision for people counting. The system provides for manual input and real time transmission of information regarding antitheft labels attached to paid for goods. A local control unit and a central control unit may be used. Analysis and statistical processing of results may be displayed by the local or central control unit.

Detectag, Inc. of Ontario, Canada, provides a system that uses transceivers connected to a controller using a user's private ethernet network. The transceivers monitor the activity of RFID tags in a store. The user can connect numerous controller modules on the network. The transceivers are equipped with self-diagnostic software. Additionally, the transceivers are tamper-resistant. If the transceiver detects tampering, the transceiver generates an audible alarm. The system may also use a speech module and a relay driver module. The speech module allows a user to record and then play back voice messages or instructions. For example, the system can greet someone as he or she enters a building. Similarly, the system can inform users of certain building security procedures. The relay driver module allows a user to control power to separate external devices. The module is essentially a remote on and off switch. This system provides for, for example, turning on and off of electric locks, alarm modules, and building lights.

U.S. Pat. No. 5,748,085 (Davis et al.) is directed to an EAS event monitoring system. This system is capable of recording alarm and other events associated with the operation of the EAS system. The monitor may have alarm detection capability, an alphanumeric keyboard for event code entry by an employee, memory for storage of event data and employee identification, and means for downloading data to a portable reader or central processor. This monitoring system allows store managers and EAS manufacturers to audit the performance of installed EAS systems. It provides store managers with a means of recording and thereby assessing whether store employees are responding appropriately to EAS events.

However, presently known systems have a number of shortcomings resolved by the present invention. Most importantly, presently known system provide no analysis of data, for example, no graphical displays of the frequency of stolen items are provided along with no data as to why specific alarms are triggered.

All references cited herein are incorporated herein by reference in their entireties.

### BRIEF SUMMARY OF THE INVENTION

The present invention preferably includes all of the advantages of the systems identified above (e.g., interface with store alarms, remote diagnostic hardware, remote management, data mining, people counting, alarm logs, linking of security cameras, tracking of alarms, comparison of data, monitoring of tag performance, a speech module, use of a network, etc.) but resolves shortcomings in the prior art. The present system provides a system that uses automatic reason code generation. That is, the present system automatically determines the reason for alarm. For example, the present invention automatically generates a code when an alarm has been activated because an item has been stolen. Additionally, the present system uses detailed displays such as displays having annotated maps to quickly. provide a operator of the system with detailed information from stored event information. Finally, the present system provides a short video of an alarm event that is viewable from a central computer, remote from the site of the event.

In the present invention, a system for monitoring security systems is provided which includes at least one pedestal set (such as an RF pedestal set), a reason code generator; a computer to compile data received from the at least one pedestal set, and a graphical display to display the compiled data received from the pedestal set in the form of a maps of locations. At least one deactivating scanner, at least one people counting system and/or at least one auxiliary input may be included. The reason code generator may be an automatic reason code generator that does not require input from a human operator. The maps of locations may comprise a series of levels of maps wherein a first map displays a broadest geographic region, a second map displays a smaller geographic region of the first map with greater detail than that shown on the first map and a third map displays a smaller geographic region of the second map with greater detail than that shown on the second map, etc. The maps of locations may display coded areas wherein codes associated with the coded areas convey information related to data received from the at least one pedestal set. The coded areas that convey information related to data received from the at least one pedestal may gradually change to reflect current data. The maps of locations may comprise a filter to provide for display of certain desired data.

In an alternate embodiment of the present invention, a system for monitoring security systems includes at least one pedestal set for transmitting a signal to a tag passing near the pedestal set and receiving a signal back from tag as the tag passes near the pedestal set to establish an alarm event, at least one IP camera configured to operate for a period of time during the alarm event, a reason code generator, a computer to compile data received from the at least one pedestal set, including video data from the IP camera and reason code generator, and a graphical display to display the compiled data received from the pedestal set in the form of a maps of locations. The time period may be in a range from about one to ten seconds and, preferably, about four seconds.

A method for monitoring security systems is also provided which includes providing at least one pedestal set, passing a tag through the pedestal set to create an event, generating a reason for the event observed by the pedestal set, compiling batches of data received from the at least one pedestal set; and graphically displaying the compiled data received from the pedestal set in the form of a maps of locations. The step of deactivating the tag using a deactivating scanner may be included. The step of providing at least one people counting system may be included and the step of compiling data further may further include compiling data from the people counting system. The method may also include the step of providing at least one auxiliary input and the step of compiling data may further include compiling data from the at least one auxiliary input. The step of generating a reason for the event may include automatically generating a reason for the event without input from a human operator. The step of displaying maps of locations may include displaying a series of levels of maps wherein a first map displays a broadest geographic region, a second map displays a smaller geographic region of the first map with greater detail than that shown on the first map and a third map displays a smaller geographic region of the second map with greater detail than that shown on the second map. The step of displaying maps of locations may include displaying coded areas wherein codes associated with the coded areas convey information related to data received from the at least one pedestal set. The step of displaying coded areas may include displaying coded areas that convey information related to data received from the at least one pedestal that gradually change to reflect current data. The step of displaying coded areas may include filtering data to provide certain desired data.

In an alternate embodiment of the present invention, a method for monitoring security systems is provided which includes the steps of providing at least one pedestal set, providing at least one IP camera, transmitting a signal to a tag passing near the pedestal set and receiving a signal back from tag as the tag passes near the pedestal set to establish an alarm event, passing a tag through the pedestal set to create an alarm event, generating a reason for the event observed by the pedestal set, operating the IP camera for a period of time at the initiation of an alarm event, compiling data received from the at least one pedestal set, graphically displaying the compiled data received from the pedestal set in the form of a maps of locations, and viewing video from the IP camera at a computer remote from a location of the IP camera. The time period is preferably in a range from about one to ten seconds, and preferably about four seconds.

### BRIEF DESCRIPTION OF SEVERAL VIEWS OF THE DRAWINGS

The invention will be described in conjunction with the following drawings in which like reference numerals designate like elements throughout the several views and wherein:

FIG. 1 is a block diagram of a system for monitoring security systems in accordance with one preferred embodiment of the present invention;

FIG. 2 is a simplified drawing of an example of a display showing a map as used in the system of FIG. 1; and

FIG. 3 is a simplified drawing of an example of a display showing a second map as used in the system of FIG. 1, wherein the second map is a detail view of a portion of the first map.

### DETAILED DESCRIPTION OF THE INVENTION

The present system is directed to a novel security system that comprises a software system that receives information from a hardware system. The hardware and software systems will be described separately below.

Hardware System

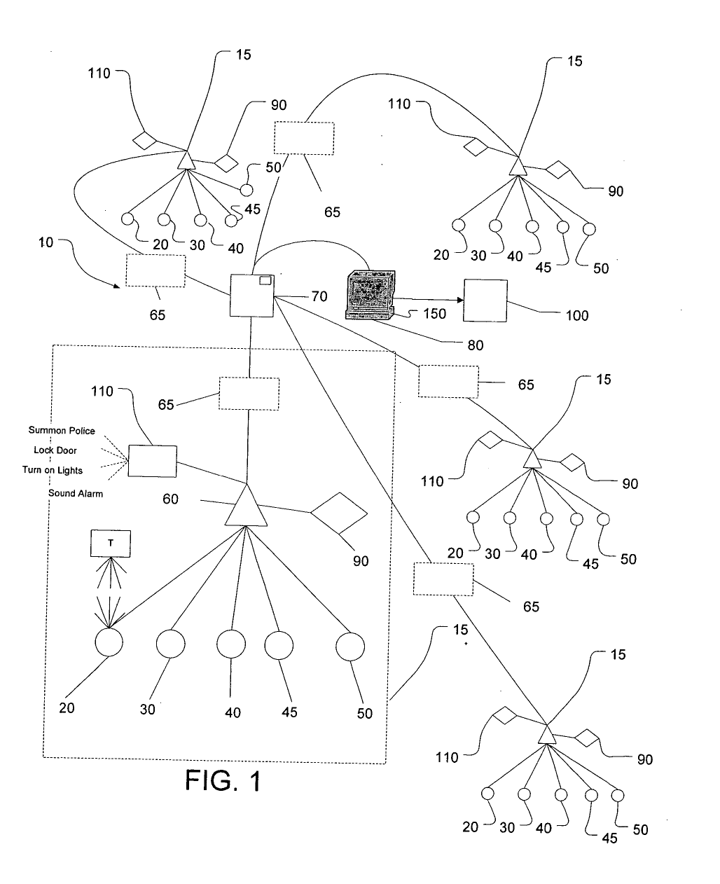

Referring now to the drawings, wherein like part numbers refer to like elements throughout the several views, there is shown in FIG. 1 a system for monitoring security systems 10 in accordance with one preferred embodiment of the present invention. The system for monitoring security systems 10 includes one or more pedestal sets 20 for sending a signal and receiving a signal from a tag T, such as an RFID tag. The system may further include, for example, a deactivating scanner 30, a people counting system 40, an IP camera 45 (a device which allows a user to view live or stored, full motion video from anywhere on a computer network) one or more auxiliary inputs 50 and a local computer 60 that is connected to server 70. These subsystems are all connected to the system for monitoring security systems 10 in accordance with a first embodiment of the present invention. The local computer 60 is connected to a reason code generator 90 (as will be described in further detail below). The local computer 60 also receives data related to information observed by the system at the pedestal sets 20, deactivating scanner 30, people counting system 40 and auxiliary inputs 50. The hardware system, i.e., the system for monitoring security systems 10, of the present invention, is compatible with a wide variety of products in a wide variety of areas, such as general security systems, shipping facilities, airports, casinos, libraries and stores (the retail industry in general). The system 10 preferably includes the pedestals 20, as are well known, connected by wire or wirelessly to send information to the server 70, preferably via the local computer 60. The server 70 processes the information received at the pedestals 20 and other attached apparatus (deactivating scanner 30, people counting system 40, etc.). As shown in FIG. 1, the pedestals 20 may connect to a hub (for example, ports in local computer 60 or a separate hardware hub 15 that has ports for other communication sources including, for example, the people counting system 40, the deactivating scanner 30, the reason code generator 90, and the auxiliary inputs 50 for other devices.

The auxiliary inputs 50 can include, for example, systems for determining electrical status information for the store or pedestals 20, closed-circuit television, information on the status of door and window locks, metal detector information, lighting in the store and the like.

Rather than feeding information to the computer 60, these systems 10, including the pedestals 20, may feed information received to the hub 15. The hub 15 acts as a server to send the information to an offsite processing station, i.e., the server 70 at, for example, facility headquarters. Optionally, a modem 65 or wireless connection may transfer the data from the hub 15 to the server 70.

The system 10 may also include one or more outputs 110 for acting on a given condition entered into the reason code generator 90 or automatically (i.e., without direct input by a human operator) by an automatic reason code generator 90. The outputs 100 are designed to effect security measures such as summon the police, lock doors, turn on lights, or sound an alarm. While installed, the components will send information to the hub 15 continuously. The hub 15 sends the information to the in-store, local computer 60 which sends the information to the offsite server 70. The offsite server 70 sends the information to a managing computer 80 or computers that are sufficiently powerful to view the security data generated. Store owners, district managers, regional managers, and the like will be able to monitor their store or stores' profile to gain useful information about the customers in the store. The managing computer 80 would preferably be a single computer located at, for example, company headquarters.

Optionally, the system 10 may include provision to view video related to a triggered condition using, for example, the IP camera 45. When triggered, the IP camera sends a short video clip to the local computer 60 or server 70.

Software System

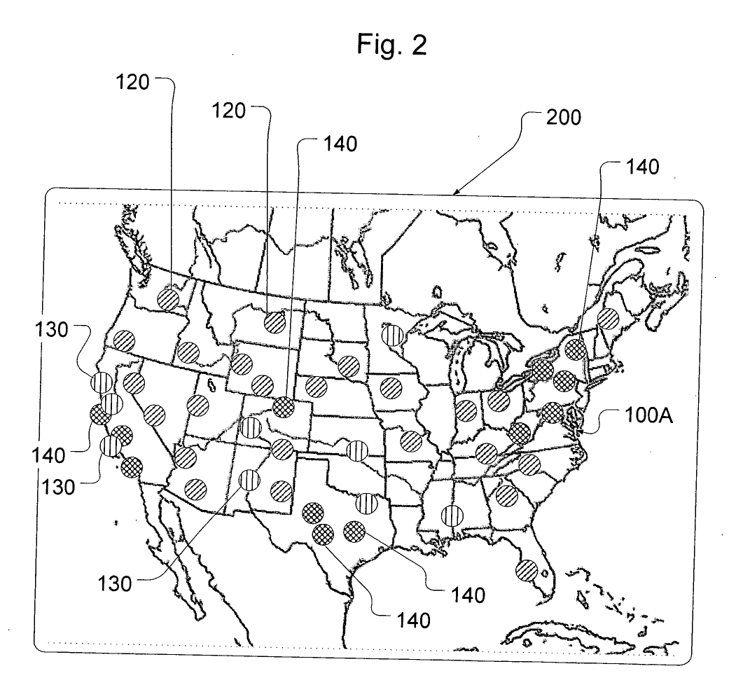

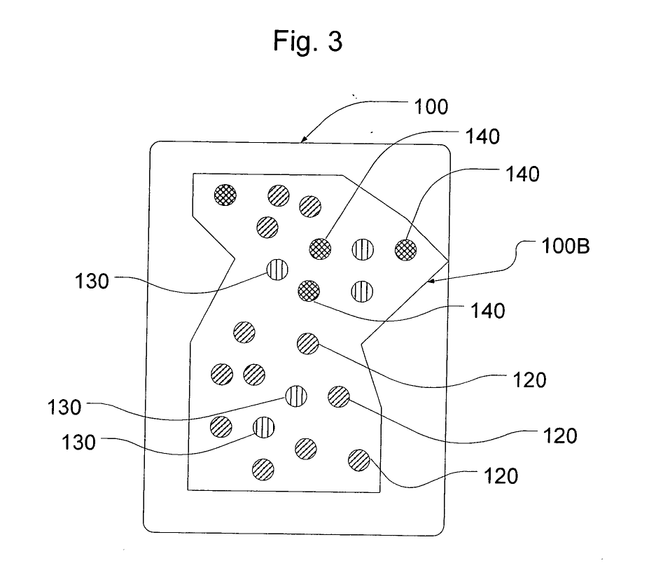

As can be seen in FIGS. 2 and 3, which depict examples of a display screen 100A, 100B of the present invention, the software system 10 creates a map display to show the security system 10 of different areas within a region associated with the security system. Each location may be coded with, for example, a color or a different type of shading (as shown in FIGS. 2 and 3). For example, a display of a red area (displayed as an area of angled lines 120 in FIGS. 2 and 3) on a map may show a security risk associated with that area while a display of a green area (displayed as an area of vertical lines 130 in FIGS. 2 and 3) on the map may show a normal (everything active and fully functional with no alerts). For each occurrence of a security event, the color of the symbol changes. For example, the color of a symbol could gradually change from green to red depending upon the number of occurrences of security events (depicted as an area of cross-hatched lines 140 in FIGS. 2 and 3). Therefore, a graphical representation offering a more precise view of data is available for viewing. For example, a map could initially start as a median color between green and red (e.g., pale green, pink or even a different color such as blue) to provide for an operator to view which locations have a greater or lesser number of security events.

In a preferred embodiment of the present invention, by clicking on the map area using a cursor associated with a mouse, the map will zoom in on a particular region (see FIG. 3 as compared to FIG. 2). For example, if an initial map shows the entire world, a operator could point to and click on a particular country (this is particularly useful for for an international corporation). If the initial map showed a country (see, e.g., FIG. 2), a particular state or city (see, e.g., FIG. 3) could be designated. Clicking again on the map could bring up information on a particular location. The location could be a structure such as a particular store, a warehouse, shipping facility, house, office building, and the like. Clicking on a particular location will display the individual record of events (such as security events) which contributed to creating the color shown on the map. The information for a particular location could be, for example, textual information such as number of alarms, number of false alarms, specific details regarding those alarms, people count for a specific day, week and month, etc. (as is well known).

In addition to the ability to zoom in on individual locations, the operator would preferably have the ability to filter by specific location (for example, using filter 150), attributes such as urban or rural locations. Preferably, the operator can view a time elapsed map (for example, the average “color” for past week or month) for a given region. In addition, this allows operators to view graphs of security conditions versus time for given locations or groups of locations.

Another feature of the system provides for an operator to remove certain data related to security codes from the system. For example, since the security codes are generated by the reason code generator or automatic reason code generator, in a retail location, the operator can remove data related to all security events that are related to, for example, false alarms. Maps and graphs can be viewed without that data.

With respect to the provision to view video described above, a user may zoom in on an individual location to look at a specific event. An icon for a short video (for example, a four second video) can be selected that shows, for example, two seconds before and two seconds after a triggering event, or four seconds immediately after a triggering event. This would provide for confirmation of the reason given for an alarm. This would be useful, for example, if an EAS event occurred outside of the working hours of the structure being monitored. If no reason was entered, the video could provide details as to what had occurred. Advantageously, the video is remote from the location where the event occurred. If this system is not available, an operator would likely have had to go to a specific location and search video or stored images to determine what occurred. The present system may accomplish this automatically. Additionally, a system operator may confirm that appropriate action was taken during an alarm condition by viewing the short video. This could assist in, for example, identifying inefficiencies in staff responses, etc. such that corrective action and support can be provided. Additionally, remote servicing of systems 10 can be provided because a video of an alarm condition can be remotely viewed to determine if a genuine or “phantom” alarm took place.

While the invention has been described in detail and with reference to specific examples thereof, it will be apparent to one skilled in the art that various changes and modifications can be made therein without departing from the spirit and scope thereof.

What is claimed is:

1. A system for monitoring security systems, comprising:
(A) at least one pedestal set;
(B) a reason code generator;
(C) a computer to compile data received from the at least one pedestal set; and
(D) a graphical display to display the compiled data received from the pedestal set in the form of a maps of locations.

2. The system for monitoring security systems of claim 1, comprising at least one deactivating scanner.

3. The system for monitoring security systems of claim 1, comprising at least one people counting system.

4. The system for monitoring security systems of claim 1, comprising at least one auxiliary input.

5. The system for monitoring security systems of claim 1, wherein the reason code generator is an automatic reason code generator that does not require input from a human operator.

6. The system for monitoring security systems of claim 1, wherein the maps of locations comprise a series of levels of maps wherein a first map displays a broadest geographic region, a second map displays a smaller geographic region of the first map with greater detail than that shown on the first map and a third map displays a smaller geographic region of the second map with greater detail than that shown on the second map.

7. The system for monitoring security systems of claim 1, wherein the maps of locations display coded areas wherein codes associated with the coded areas convey information related to data received from the at least one pedestal set.

8. The system for monitoring security systems of claim 1, wherein the coded areas that convey information related to data received from the at least one pedestal gradually change to reflect current data.

9. The system for monitoring security systems of claim 1, wherein the maps of locations comprise a filter to provide for display of certain desired data.

10. A system for monitoring security systems, comprising:
(A) at least one pedestal set for transmitting a signal to a tag passing near the pedestal set and receiving a signal back from tag as the tag passes near the pedestal set to establish an alarm event;
(B) at least one IP camera configured to operate for a period of time during the alarm event;
(C) a reason code generator;
(D) a computer to compile data received from the at least one pedestal set, including video data from the IP camera and reason code generator; and
(E) a graphical display to display the compiled data received from the pedestal set in the form of a maps of locations.

11. The system for monitoring security systems of claim 10, wherein the time period is in a range from about one to ten seconds.

12. The system for monitoring security systems of claim 10, wherein the maps of locations comprise a series of levels of maps wherein a first map displays a broadest geographic region, a second map displays a smaller geographic region of the first map with greater detail than that shown on the first map and a third map displays a smaller geographic region of the second map with greater detail than that shown on the second map.

13. The system for monitoring security systems of claim 1, wherein the maps of locations display coded areas wherein codes associated with the coded areas convey information related to data received from the at least one pedestal set.

14. The system for monitoring security systems of claim 1, wherein the coded areas that convey information related to data received from the at least one pedestal gradually change to reflect current data.

15. The system for monitoring security systems of claim 1, wherein the maps of locations comprise a filter to provide for display of certain desired data.

16. A method for monitoring security systems, comprising:
(A) providing at least one pedestal set;
(B) passing a tag through the pedestal set to create an event;
(C) generating a reason for the event observed by the pedestal set;
(D) compiling batches of data received from the at least one pedestal set; and
(E) graphically displaying the compiled data received from the pedestal set in the form of a maps of locations.

17. The method for monitoring security systems of claim 16, including deactivating the tag using a deactivating scanner.

18. The method for monitoring security systems of claim 16, including providing at least one people counting system and wherein the step of compiling data further includes compiling data from the people counting system.

19. The method for monitoring security systems of claim 16, including providing at least one auxiliary input and wherein the step of compiling data further includes compiling data from the at least one auxiliary input.

20. The method for monitoring security systems of claim 16, wherein the step of generating a reason for the event includes automatically generating a reason for the event without input from a human operator.

21. The method for monitoring security systems of claim 16, wherein the step of displaying maps of locations includes displaying a series of levels of maps wherein a first map displays a broadest geographic region, a second map displays a smaller geographic region of the first map with greater detail than that shown on the first map and a third map displays a smaller geographic region of the second map with greater detail than that shown on the second map.

22. The method for monitoring security systems of claim 16, wherein the step of displaying maps of locations includes displaying coded areas wherein codes associated with the coded areas convey information related to data received from the at least one pedestal set.

23. The method for monitoring security systems of claim 16, wherein the step of displaying coded areas includes displaying coded areas that convey information related to data received from the at least one pedestal that gradually change to reflect current data.

24. The method for monitoring security systems of claim 16, wherein the step of displaying coded areas includes filtering data to provide certain desired data.

25. A method for monitoring security systems, comprising:
(A) providing at least one pedestal set;
(B) providing at least one IP camera;
(C) transmitting a signal to a tag passing near the pedestal set and receiving a signal back from tag as the tag passes near the pedestal set to establish an alarm event;
(D) passing a tag through the pedestal set to create an alarm event;
(E) generating a reason for the event observed by the pedestal set;
(F) operating the IP camera for a period of time at the initiation of an alarm event;
(G) compiling data received from the at least one pedestal set;
(H) graphically displaying the compiled data received from the pedestal set in the form of a maps of locations; and
(I) viewing video from the IP camera at a computer remote from a location of the IP camera.

26. The method for monitoring security systems of claim 25, wherein the time period is in a range from about one to ten seconds.

27. The method for monitoring security systems of claim 25, wherein the step of graphically displaying the compiled data includes displaying a series of levels of maps wherein a first map displays a broadest geographic region, a second map displays a smaller geographic region of the first map with greater detail than that shown on the first map and a third map displays a smaller geographic region of the second map with greater detail than that shown on the second map.

28. The method for monitoring security systems of claim 25, wherein the step of graphically displaying maps of locations includes displaying coded areas wherein codes associated with the coded areas convey information related to data received from the at least one pedestal set.

29. The method for monitoring security systems of claim 25, wherein the coded areas that convey information related to data received from the at least one pedestal gradually change to reflect current data.

30. The method for monitoring security systems of claim 25, filtering data to provide for display of certain desired data.
